(19) United States
(12) Patent Application Publication
(10) Pub. No.: US 2009/0228620 A1
(43) Pub. Date: Sep. 10, 2009

(54) Digital Adapter

(76) Inventors: Fred Thomas, Fort Collins, CO (US); Paul Cesario, Fort Collins, CO (US); Bryce Wemple, Fort Collins, CO (US); Eric Peterson, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/241,246

(22) Filed: Sep. 30, 2008

Related U.S. Application Data
(60) Provisional application No. 61/034,063, filed on Mar. 5, 2008.

(51) Int. Cl. G06F 13/38

(52) U.S. Cl. 710/65

(57) ABSTRACT

In one embodiment, a digital adapter comprises at least one data input port to receive a digital signal originating from a network attached storage device coupled to the digital adapter, at least one data output port to interface with a digital rendering device communicatively coupled to the digital adapter; and digital signal converter logic to convert the digital signal originating from the network attached storage device from a first signal format to a second signal format, different from the first signal format, and transmit the digital signal in the second signal format through the at least one data output port.

### CROSS-REFERENCE TO RELATED APPLICATION

This application claims the benefit of Provisional Patent Application No. 61/034,063, filed 5 Mar. 2008, and titled, “Digital Adapter” the entirety of which is hereby incorporated by reference herein.

### BACKGROUND

The term Network Attached Storage (NAS) refers to a dedicated data storage device(s) connected directly to a computer network to provide centralized data access and storage services to one or more network clients such as, e.g., a personal computer. In some circumstances it may be useful to allow for connectivity between a NAS device and a digital rendering device to view content stored on the NAS device.

### BRIEF DESCRIPTION OF THE DRAWINGS

FIG. 1 is a schematic illustration of one embodiment of network environment with network attached storage devices and a digital adapter.

FIG. 2 is a schematic illustration of one embodiment of a digital adapter.

FIG. 3 is a schematic illustration of one embodiment of a network attached storage device with a digital adapter.

FIG. 4 is a flowchart illustrating operations in one embodiment of digital adapter system.

FIG. 5 is a flowchart illustrating operations in one embodiment of a digital adapter system.

FIG. 6 is a schematic illustration of one embodiment of a digital rendering device and a digital adapter.

### DETAILED DESCRIPTION

Described herein are exemplary systems and methods for a digital adapter in a network environment. The methods described herein may be embodied as logic instructions stored on a computer-readable medium. When executed on a processor, the logic instructions cause a general processor to be programmed as a special-purpose machine that implements the described methods. The processor, when configured by the logic instructions to execute the methods recited herein, constitutes structure for performing the described methods.

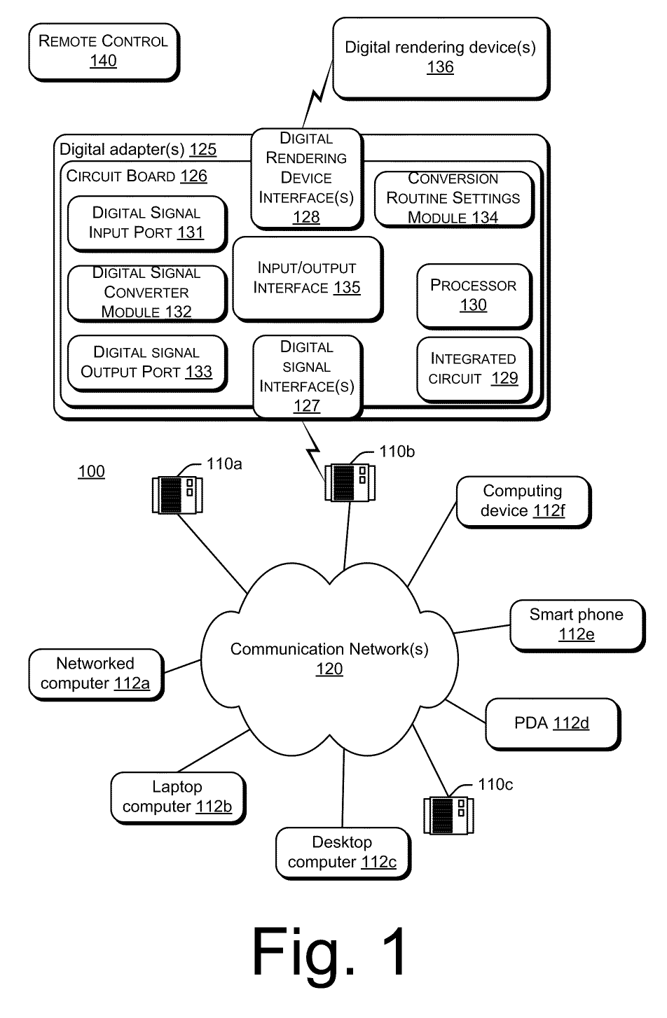

FIG. 1 is a schematic illustration of one embodiment of network environment with a digital adapter communicatively connected to a network attached storage device and a digital rendering device. Environment 100 may comprise one or more network attached storage devices 110a, 110b, 110c connected to one or more network clients 112a, 112b, 112c, 112d, 112e, 112f, and/or one or more digital adapter(s) 125 by a communication network 120. Environment 100 may comprise one or more digital rendering devices 130.

Network attached storage devices 110a, 110b, 110c may be implemented as one or more communicatively connected storage devices. Exemplary storage devices may comprise, but are not limited to, the HP MediaSmart Server line of storage devices commercially available form Hewlett-Packard Corporation of Palo Alto, Calif., USA. In some embodiments, at least a portion of communication network 120 may be implemented as a private, dedicated network such as, e.g., a local area network (LAN) or a wide area network (WAN). Alternatively, portions of communication network 120 may be implemented using public communication networks pursuant to a suitable communication protocol such as, e.g., the Internet.

Network clients 112a, 112b, 112c, 112d, 112e, 112f may be implemented as computing devices such as, e.g., a networked computer 112a, a laptop computer 112b, a desktop computer 112c, a personal digital assistant (PDA) 112d, a smart phone 112e, other computing devices 112f or the like. Applications running on network clients 112a, 112b, 112c, 112d, 112e, 112f may initiate file access requests to access information stored in network attached storage devices 110a, 110b, 110c. Network attached storage devices 110a, 110b, 110c receive file access requests and, in response, locate and return the requested information to the network client that originated the request.

A network attached storage device 110 may be communicatively connected to a digital adapter 125. By way of example and not limitation, a network attached storage device and a digital adapter may be connected via a serial interface such as a Universal Serial Bus (USB), an external Serial advanced technology attachment (eSATA), a Firewire or the like. In operation, a connection via a high speed serial interface allows for transmission of uncompressed digital video formats, digital audio formats, digital image formats or the like.

Among other components, the digital adapter 125 comprises a circuit board 126. The circuit board 126 may comprise at least one integrated circuit 129 and in practice typically comprises a plurality of integrated circuits 129. In some embodiments, the circuit board 126 may comprise at least one processor 130. In some embodiments, a digital adapter may include a plurality of processors 130.

Among other components, a digital adapter 125 may include at least one digital signal interface 127, and at least one digital rendering device interface 128. In some embodiments, digital signal interface 127 and digital rendering device interface 128 are communicatively connected to the circuit board 126. In some embodiments, a digital signal interface 127 may comprise a serial port to receive digital signals from a network attached storage device 110. In some embodiments, a digital signal interface 127 may include a cable to connect to a port in a network attached storage device 110 or the like. In operation, a network attached storage device 110 may transmit an uncompressed digital signal containing video content, music content, or the like, to a digital signal interface 127 which may receive the signal and allow the signal to be processed in the digital adapter 125.

A digital rendering device interface 128 may comprise ports and/or cables to allow for communication with one or more digital rendering devices 136 such as a HDTV, monitor or the like. By way of example and not limitation, a digital rendering device interface 128 ports and/or cables may use formats such as HDMI, BNC, or other renderable physical interface connectors.

In some embodiments, the digital adapter 126 may include logic to convert digital signals from a first received digital format to a second different digital format. By way of example, a digital adapter may convert a signal received from an eSATA interface and convert the signal to one which may be transmitted through a high definition media interface.

A digital adapter 125 may comprise, among other components, a digital signal input module 131, a digital signal converter module 132, a digital signal output module 133, and a conversion routine settings module 134.

A digital signal input module 131 may include logic to receive digitals signals in a digital adapter 125. In some embodiments, a digital signal input module 131 may receive a digital signal from a digital signal interface 127 which may be communicatively connected to through a circuit board 126 or the like. In some embodiments, a digital signal input module 131 may also defect a digital signal format from a digital signal received from a digital signal interface 127.

A digital signal converter module 132 may include logic to receive a digital signal from a digital signal input module 131 and transcode the signal to a different format. In some embodiments, a digital signal converter module 132 may transcode a single input video format to HDMI, composite video, or the like. In some embodiments, a digital signal converter module 132 may use a default conversion routine to transcode received digital signals. In some embodiments, a digital signal converter module 132 may receive conversion routine settings from a conversion routine settings module 134. By way of example and not limitation, a digital signal converter module 132 may transcode a digital signal received from an eSATA interface to a format which may be communicated over a HDMI.

A digital signal output module 133 may include logic to transmit a digital signal to a digital rendering device interface 128. By way of example and not limitation, a digital video signal may be outputted to a digital rendering device interface 128 using formats such as HDMI, BNC or other renderable video physical interfaces.

A conversion routine settings module 134 may include logic to allow a user to select options and/or functionalities for a digital adapter 125. In some embodiments, a conversion routine settings module 134 may receive setting selections from sources such as; a touch screen, a number pad, a remote control 140 or the like.

In some embodiments, a digital adapter 125 may comprise a remote control 140. In some embodiments, a remote control 140 may allow a user to interface with a digital adapter 125, and thereby may allow a user to choose among settings on a digital adapter 125. In some embodiments, a remote control may allow a user to input setting choices through a digital rendering device such as the digital rendering device 136. Furthermore, in some embodiments, a remote control 140 may allow a user to access functionalities of a digital rendering device 136 such as; video playback, audio playback, volume, or the like. In some embodiments, a digital adapter comprise logic to transmit a settings menu to a digital rendering device and receive, from a remote control, at least one settings selection for input and output data formats.

In some embodiments, a digital adapter 125 may include an input/output interface 135. In some embodiments, an input/output interface 135 may include a touch screen, a number pad or the like, and may allow a user to select among conversion routines and/or other functionalities of a digital adapter 125. In some embodiments, a digital adapter may comprise an input/output interface and logic to; display, on the input/output interface, current data format selections and data format options, receive, in a digital adapter, data format selections, and process, in a digital adapter, the selected data format selections. In some embodiments, a digital adapter may comprise logic to; display, on a digital rendering device, current data format selections and data format options, receive, in a digital adapter, data format selections, and process, in a digital adapter, the selected data format selections.

In operation, a digital adapter 125 may provide a dedicated video interface from the central storage location, such as a network attached storage device or the like, to a digital video rendering device without the necessity to use lower bandwidth and lower quality of service data transmissions means such as Ethernet or the like. Furthermore, in operation, by harnessing the computational power of a network attached storage device or the like, a digital adapter is not burdened with processor intensive compressing and decompressing of digital content.

A digital adapter 125 may convert digital signals received from a network attached storage device to a format that may be transmitted to a digital rendering device 130. A digital adapter 125 may be communicatively connected to a digital rendering device 138. In some embodiments, a digital adapter and a digital rendering device are connected through interfaces such as; HDMI, BNC, composite video, WiFi or the like. By way of example and not limitation, a digital adapter may convert digital formats such as; Moving Picture Expert Group (MPEG), MPEG-1, MPEG-2, MP3, VideoCD, MPEG-4, Motion JPEG, Digital Video, Windows Media Video (WMV), Real Media DivX, Sorenson 3, Quicktime 6, RP9, WMV9 or the like, to real-time renderable outputs such as; High Definition Media Interface (HDMI), BNC, composite video, or the like. In operation, a network attached storage device may send an uncompressed digital video to a digital adapter via an eSATA interface, a digital adapter may then transcode the digital content to a format that may be transmitted through a HDMI cable to a digital rendering device such as a HDTV.

In operation, the connectivity between a digital adapter and a digital rendering advice allows for communication of high bandwidth data with less likelihood of a user experiencing interruptions.

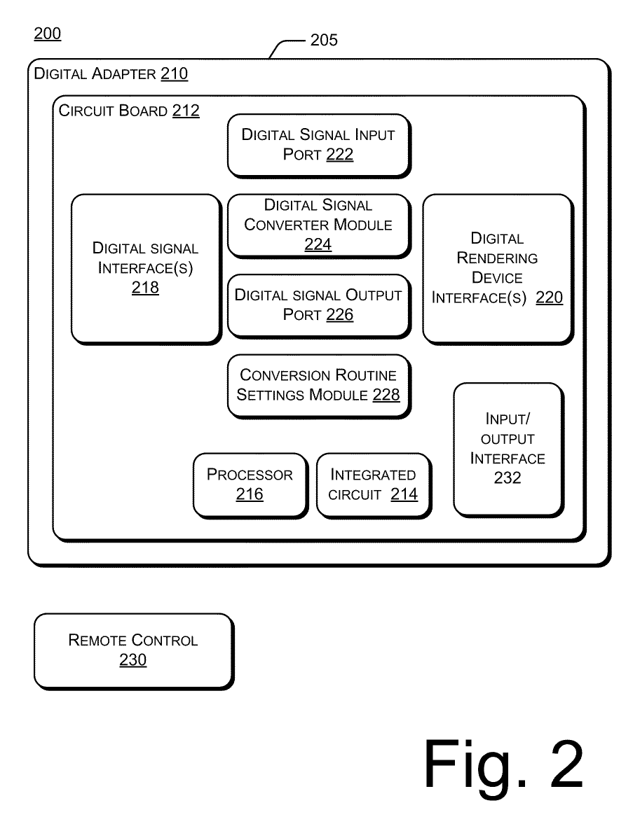

FIG. 2 is a schematic illustration of one embodiment of a digital adapter 200, which may be used to implement one or more digital adapters 125 depicted in FIG. 1. Referring to FIG. 2, digital adapter 200 comprises a housing 205 defining a chamber 210. Components of the digital adapter 200 reside within the chamber 210. Among other components, the digital adapter comprises a circuit board 212 positioned in the chamber 210. The circuit board 212 comprises at least one integrated circuit 214 and in practice typically comprises a plurality of integrated circuits 214. In some embodiments, the circuit board 212 may comprise at least one processor 216. In some embodiments a digital adapter may include a plurality of processors 216.

Among other components, the housing 205 may include at least one digital signal interface 218, and at least one digital rendering device interface 220 formed in the housing 205. In some embodiments, digital signal interface 218 and digital rendering device interface 220 are communicatively connected to the circuit board 212. In some embodiments, a digital signal interface 218 may comprise a serial port to receive digital signals from a network attached storage device. In some embodiments, a digital signal interface 218 may include a cable to connect to a port in a network attached storage device or the like. In operation, a network attached storage device may transmit an uncompressed digital signal containing video content, music content, or the like, the digital signal interface 218 may receive the signal and allow the signal to be processed in the digital adapter.

A digital rendering device interface 220 may comprise ports and/or cables to allow for communication with digital rendering devices such as an HDTV, monitor or the like. By way of example and not limitation, a digital rendering device interface 220 ports and/or cables may use formats such as HDMI, BNC, or other renderable physical interface connectors.

In some embodiments, the digital adapter 200 may include logic to convert digital signals from a received digital format to a different digital format. By way of example, a digital adapter may convert a signal received via an eSATA interface and convert the signal to one which may be transmitted via a high definition media interface. A digital adapter 200 may comprise, among other components, a digital signal input module 222, a digital signal converter module 224, a digital signal output module 226, and a conversion routine settings module 228.

A digital signal input module 222 may include logic to receive digitals signals in a digital adapter 200. In some embodiments, a digital signal input module 222 may receive a digital signal from a digital signal interface 218 which may be communicatively connected to via a circuit board 212 or the like. In some embodiments, a digital signal input module may also defect a digital signal format from a received signal.

A digital signal converter module 224 may include logic to receive a digital signal from a digital signal input module 222 and transcode the signal to a different format. In some embodiments, a digital signal converter module 224 may transcode a single input video format to HDMI, composite video, or the like. In some embodiments, a digital signal converter module 224 may use a default conversion routine to transcode received digital signals. In some embodiments, a digital signal converter module 224 may receive conversion routine settings from a conversion routine settings module 228. By way of example and not limitation, a digital signal converter module 224 may transcode a digital signal received via an eSATA interface to a format which may be communicated over a HDMI.

A digital signal output module 226 may include logic to transmit a digital signal to a digital rendering device interface 220. By way of example and not limitation, a digital video signal may be outputted to a digital rendering device interface 220 using formats such as HDMI, BNC or other renderable video physical interfaces.

A conversion routine settings module 228 may include logic to allow a user to select options and/or functionalities for a digital adapter 200. In some embodiments, a conversion routine settings module 228 may receive setting selections from sources such as; a touch screen, a number pad, a remote control 230 or the like.

In some embodiments, a digital adapter 200 may comprise a remote control 230. In some embodiments, a remote control 230 may allow a user to interface with a digital adapter 200, and thereby may allow a user to choose among settings on a digital adapter 200. In some embodiments, a remote control may allow a user to input setting choices via a digital rendering device such as the digital rendering device 130 depicted in FIG. 1. Furthermore, in some embodiments, a remote control may allow a user to access functionalities of a digital rendering device such as; video playback, audio playback, volume, or the like.

In some embodiments, a digital adapter 200 may include an input/output interface 232. In such embodiments, an input/output interface 232 may include a touch screen, a number pad or the like, and may allow a user to select among conversion routines and/or other digital adapter functionalities.

In operation, a digital adapter 200 may provide a dedicated video interface from the central storage location, such as a network attached storage device or the like, to a digital video rendering device without the necessity to use lower bandwidth and lower quality of service data transmissions means such as Ethernet or the like. Furthermore, in operation, by harnessing the computational power of a network attached storage device or the like, a digital adapter is not burdened with processor intensive compressing and decompressing of digital content.

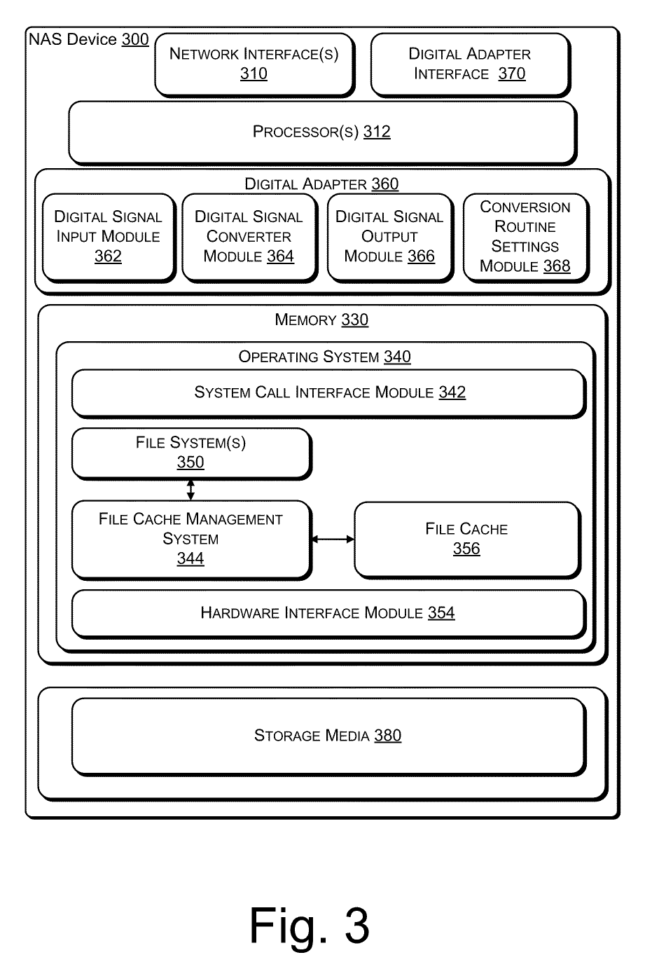

FIG. 3 is a schematic illustration of one embodiment of a network attached storage device with a digital adapter. Referring to FIG. 3, network storage device 300 comprises one or more network interfaces 310 which enable a communication connection with a network such as, e.g., network 120. The network storage device may comprise one or more digital adapter interfaces 370 which enable a communication connection with a digital rendering device such as, e.g. digital rendering device 130.

Network interface 310 may comprise an input/output (I/O) port to provide a physical connection with a network. For example, network interface 310 may comprise an Ethernet port. Network interface 310 may comprise a network interface card (NIC), also commonly referred to as a network adapter or a network card. The NIC manages I/O operations to enable NAS device 300 to communicate over a network. Alternatively, the operations of the NIC may be implemented on a main circuit board such as, e.g., a motherboard of NAS device 300.

Digital adapter interface 370 may comprise an input/output (I/O) port to provide physical connection to a digital rendering device such as, a television, a high definition television or the like. By example, and not limitation, a digital adapter interface 370 may comprise a high definition media interface (HDMI) port, a BNC port or the like. Digital adapter interface 370 may comprise a network interface card (NIC), also commonly referred to as a network adapter or a network card. The NIC manages I/O operations to enable NAS device 300 to communicate over a network and/or to other computing devices directly. Alternatively, the operations of the NIC may be implemented on a main circuit board such as, e.g., a motherboard of NAS device 300.

NAS device 300 further comprises at least one processor 312. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

NAS device 300 further comprises system random access memory and/or read-only memory 330. Memory 330 comprises an operating system 340 for managing operations of NAS device 300. In one embodiment, operating system 340 comprises a hardware interface module 354 that provides an interface to system hardware. The particular embodiment of operating system 340 is not critical to the subject matter described herein. Operating system 340 may be embodied as a UNIX operating system or any derivative thereof (e.g., Linux, Solaris, etc.) or as a Windows® brand operating system.

Operating system 340 comprises (or interfaces with) a file system(s) 350 that manages files used in the operation of NAS device 200. For example, file system(s) 350 may implement one or more of a Network File System (NFS) protocol, a Common Internet File System (CIFS) protocol, or the like. In one embodiment operating system 340 may comprise a file cache management system 344 interposed logically between the file system(s) 350 and underlying modules such as, e.g., the hardware interface module 354. File cache management system 344 interfaces with the file system(s) 350 to manage the file cache 356 as a resource that may be shared between users of the computer system, e.g., on a per-workload basis.

Operating system 340 further comprises a system call interface module 242 that provides an interface between the operating system 340 and one or more application modules that execute on NAS device 300.

NAS device 300 further comprises storage media 380. For example, storage media 380 may be embodied as one or more arrays of magnetic disk drives. Alternatively, storage media 380 may comprise optical, magneto-optical, or electro-optical storage media. Storage media 380 may be configured to implement RAID redundancy.

NAS device 300 further comprises a digital adapter 360. In some embodiments, a digital adapter is embodied as a software module that executes on processor(s) 312. In some embodiments, the digital adapter 300 may include logic to convert digital signals from a received digital format to a different digital format. By way of example, a digital adapter may convert a signal received via an eSATA interface and convert the signal to one which may be transmitted via a high definition media interface. A digital adapter 300 may comprise, among other components, a digital signal input module 362, a digital signal converter module 364, a digital signal output module 366, and a conversion routine settings module 368.

A digital signal input module 362 may include logic to receive digitals signals in a digital adapter 300. In some embodiments, a digital signal input module 362 may receive a digital signal from a digital adapter interface 370. In some embodiments, a digital signal input module 362 may also defect a digital signal format of a received signal.

A digital signal converter module 364 may include logic to receive a digital signal from a digital signal input module and transcode the signal to a different format. In some embodiments, a digital signal converter module 364 may transcode a single input video format to HDMI, composite video, or the like. In some embodiments, a digital signal converter module 364 may use a default conversion routine to transcode received digital signals. In some embodiments, a digital signal converter module 364 may receive conversion routine settings from a conversion routine settings module 368. By way of example and not limitation, a digital signal converter module 364 may convert a digital signal received via an eSATA interface to a format which may be communicated over a HDMI.

A digital signal output module 366 may include logic to transmit a digital signal to a digital rendering device interface 220. By way of example and not limitation, a digital video signal may be outputted to a digital adapter interface 370 using formats such as HDMI, BNC or other renderable video physical interfaces.

A conversion routine settings module 368 may include logic to allow a user to select options and/or functionalities of a digital adapter 300. In some embodiments, a conversion routine settings module may receive setting selections from sources such as; a touch screen, a number pad, a remote control or the like.

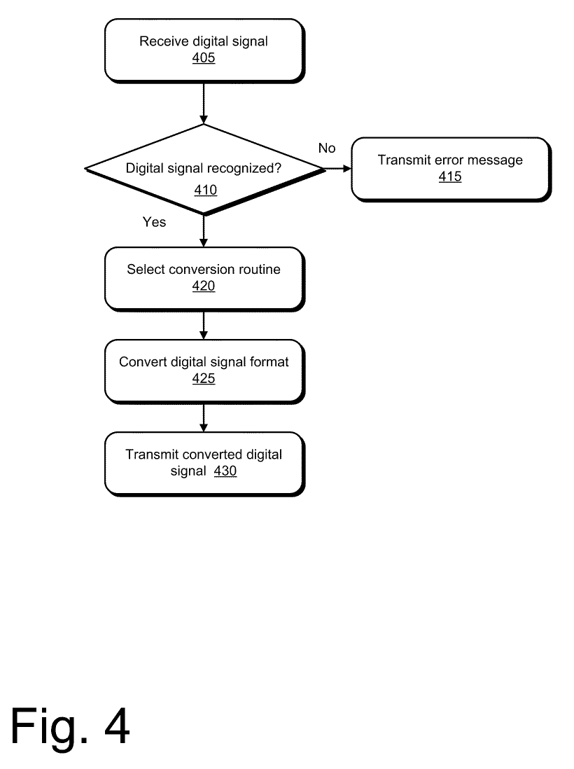

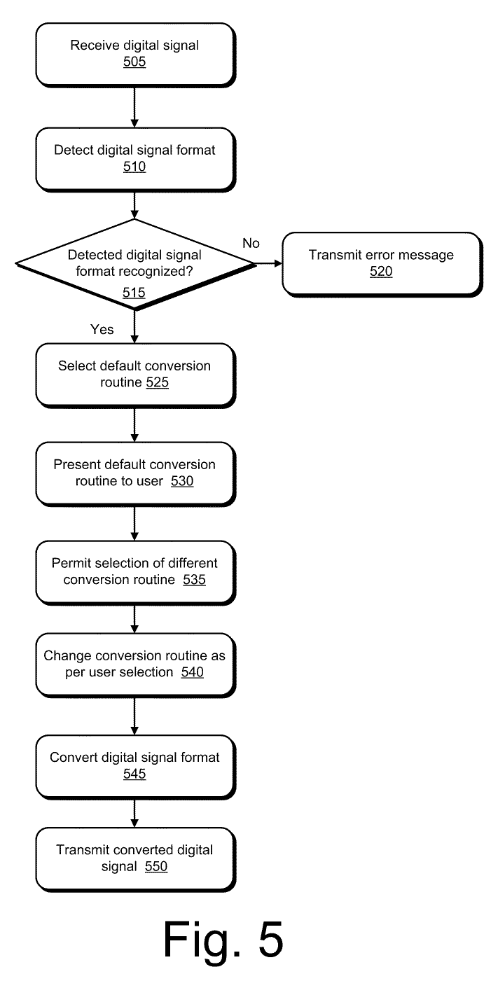

Operations implemented by some embodiments of digital adapter 200 and digital adapter 360 are described with reference to FIG. 4 and FIG. 5.

FIG. 4 is a flowchart illustrating operations in one embodiment of a method of using a digital adapter. At operation 405 a digital signal is received. In some embodiments, receiving a digital signal may comprise detecting the format of data in the digital signal, selecting a default conversion routine, presenting the default conversion routine on a input/output interface, permitting selection of a different conversion routine, changing conversion routine as per the selection from the input/output interface, and in response to a determination that the digital adapter supports the detected format, initiating a digital signal data converter. In some embodiments, the signal may be received from a network attached storage device. In some embodiments, a digital adapter may be integrated into a network attached storage device, and may receive a digital signal directly through the network attached storage device. By way of example, and not limitation, a signal may be received via a high speed serial input such as a USB interface, an eSATA interface, a Firewire interface or the like.

If at operation 410, the format of the digital signal is recognized then the digital adapter selects an appropriate conversion routine (Operation 420). By contrast, if at operation 410 the format of the digital signal is not recognized by the digital adapter, then an error message is transmitted (Operation 415).

At operation 425, the digital adapter converts the received digital signal into a different digital signal format. In some embodiments, a digital adapter has a default format into which a signal is to be converted. In some embodiments, a user may select which signal format to use after conversion. In some embodiments, a digital adapter may detect an output signal format from an active output interface and convert the digital signal to that format.

Finally, at operation 430, the converted digital signal is transmitted from the digital adapter. In some embodiments, the converted digital signal is transmitted to a digital rendering device. By way of example and not limitation, the transmission interface may include output formats such as HDMI, BNC, composite audio and video, or the like.

FIG. 5 is a flowchart illustrating operations in one embodiment of use of a digital adapter in a network environment. At operation 505 a digital signal is received. In some embodiments, the signal may be received from a network attached storage device. In some embodiments, a digital adapter may be integrated into a network attached storage device, and may receive a digital signal directly through the network attached storage device. By way of example, and not limitation, a signal may be received via a high speed serial input such as a USB interface, an eSATA interface, a Firewire interface or the like.

At operation 510, the format of the digital signal is determined. If at operation 515, the format of the digital signal is recognized then the digital adapter selects an appropriate conversion routine (Operation 525). By contrast, if at operation 515 the format of the digital signal is not recognized by the digital adapter, then an error message is transmitted (Operation 520).

At operation 525, the digital adapter selects a default conversion routine determined by the format of the received digital signal. In some embodiments, a digital adapter has a default conversion routine which has been programmed in by a manufacturer. In some embodiments, a user may select which conversion routine to use as a default. In some embodiments, a digital adapter may detect an output signal format from an output port and select a default conversion routine compatible with the detected output format.

At operation 530, the selected default conversion routine is presented to a user. In some embodiments, the default conversion routine may be presented via an input/output interface communicatively connected to a digital adapter. In some embodiments, the default conversion routine may be presented via a digital rendering device communicatively connected to the digital adapter.

At operation 535, a user may select a different conversion routine from the default routine. In some embodiments, this selection may be performed by interacting with a user interface such as a touch screen, number pad or the like. In some embodiments, a user may select an alternative conversion routine through a remote control communicatively connected to a digital rendering device such as a television, monitor or the like.

At operation 540, a user selected conversion routine is communicated to a digital adapter. In some embodiments, the user's selection is communicated to a digital adapter via a user interface on the digital adapter such as a touch screen, number pad or the like. In some embodiments, a user's selection is communicated through a signal from a digital rendering device that may have inputted via a remote control or the like.

At operation 545, a digital adapter converts an input digital signal with a first format into a digital signal with a second format that has been selected by a user. By way of example and not limitation, a received digital signal may be transmitted through an eSATA interface and converted to transmit through a high definition media interface.

Finally, at operation 550, the converted digital signal is transmitted from the digital adapter. In some embodiments, the converted digital signal is transmitted to a digital rendering device such as a television, HDTV, computer monitor or the like. By way of example and not limitation, the transmission interface may include output formats such as HDMI, BNC, composite audio and video, or the like.

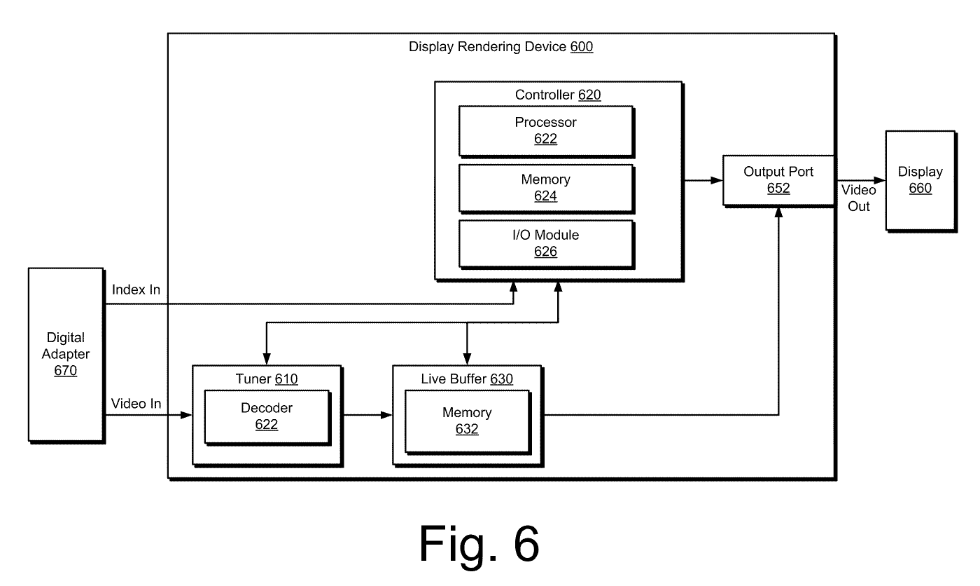

FIG. 6 is a schematic illustration of one embodiment of a digital rendering device. The components shown in FIG. 6 are only examples, and are not intended to suggest any limitation as to the scope of the functionality of the invention; the invention is not necessarily dependent on the features shown in FIG. 6.

Referring to FIG. 6, in one embodiment digital rendering device 600 comprises a tuner 610 coupled to a first live buffer 630, a controller 620, file store 640, and an output port 650. A display device 660 may be coupled to the output port 652. Display device may be embodied as, e.g., a television, a cathode ray tube (CRT), a liquid crystal display (LCD) computer screen, or any other suitable display device. By way of illustration only, and not limitation, a digital rendering device 600 will be described with reference to a multi-media personal computer system. However, as described above, it will be recognized by one of ordinary skill in the art that the disclosed subject matter may be employed as part of a personal video recorder (PVR), television, handheld Internet appliance or any other suitable device or system employing a display device. A digital adapter 670 may be coupled to the digital rendering device. By way of example and not limitation, a digital adapter may be coupled to a digital rendering device by a HDMI, BNC, other renderable physical interfaces or the like.

The tuner 610 may be embodied as any suitable tuners that may receive digital or analog video and audio information for display on display 660. In embodiments in which the tuners 610 is implemented as a television tuner, it may include a decoders 612 to perform analog to digital conversion, digital to analog conversion, or both.

Tuner 610 is coupled to receive an incoming video signal from a first communication channel, such as incoming signals from digital adapter 670. If the incoming signal is digital information, then decoder 612 may decompress the information and/or performs format conversion if necessary. As used herein, the term “channel” may include any suitable frequency or code or any other suitable delineation used to distinguish among channels containing differing video information. In some embodiments, the digital rendering device 600 may receive a second input such as, e.g., an index file, via a second channel, or through a separate communication method such as Ethernet or Internet.

In some embodiments, digital rendering deice 600 may include a live buffer 630 is coupled to tuner 610 to store video received in tuner 610 for controlled playback. Buffer 630 includes a memory module 632 that may store, for example, a playback file. Digital rendering device 600 may further include an output port 652 through which video signals are output to display 660.

Controller 620 includes a processor 622, a memory module 624, and an input/output (I/O) module 626. In some embodiments, controller 620 may capture quality setting information, for example, a setting indicating that the decoder should capture the video at a specific resolution. The controller 620 may be, for example, one or more suitably programmed microprocessors, DSPs, discrete logic, state machines or any other suitable hardware, software, or suitable combination thereof to perform various operations described herein. A file store 640 is coupled to controller 620.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “an embodiment” means that a particular feature, structure, or characteristic described in connection with the embodiment is comprised in at least an implementation. The appearances of the phrase “in one embodiment” in various places in the specification are not necessarily all referring to the same embodiment.

What is claimed is:

1. A digital adapter, comprising:
at least one data input port to receive a digital signal originating from a network attached storage device coupled to the digital adapter;
at least one data output port to interface with a digital rendering device communicatively coupled to the digital adapter; and
digital signal converter logic to:
convert the digital signal originating from the network attached storage device from a first signal format to a second signal format, different from the first signal format; and
transmit the digital signal in the second signal format through the at least one data output port.

2. The digital adapter of claim 1, further comprising:
a remote control; and
logic to:
transmit, to a digital rendering device, a settings menu; and
receive, from the remote control, at least one settings selection for input and output data formats.

3. The digital adapter of claim 1, further comprising:
an input/output interface; and
logic to:
display, on the input/output interface, current data format selections and data format options;
receive, in the digital adapter, data format selections; and
process, in the digital adapter, the selected data format selections.

4. The digital adapter of claim 1, further comprising logic to:
transmit, to a digital rendering device, current data format selections and data format options;
display, on the digital rendering device, current data format selections and data format options;
receive, in the digital adapter, data format selections; and
process, in the digital adapter, the selected data format selections.

5. The digital adapter of claim 1, further comprising:
an input/output interface; and
logic to:
detect the signal format of the digital signal originating from a network attached storage device;
detect the signal format of the connection with the digital rendering device;
select a default conversion routine;
present the default conversion routine on the input/output interface;
permit selection of a different conversion routine; and
change conversion routine as per the selection from the input/output interface.

6. The digital adapter of claim 1, further comprising logic to:
detect the signal format of the digital signal originating from a network attached storage device;
detect the signal format of the connection with a digital rendering device;
select a default conversion routine;
present the default conversion routine on a digital rendering device;
permit selection of a different conversion routine; and
change conversion routine as per the selection from the digital rendering device.

7. The digital adapter of claim 1, wherein the digital signal received from at least one data input port comprises data received through a serial interface.

8. The digital adapter of claim 1, wherein the digital signal transmitted from at least one data output port comprises data transmitted through a renderable physical interface.

9. A network attached storage device, comprising:
at least one storage media;
a circuit board comprising at least one integrated circuit;
at least one processor; and
a digital adapter comprising:
at least one data input port to receive a digital signal originating from a network attached storage device;
at least one data output port to interface with a digital rendering device communicatively coupled to the digital adapter; and
digital signal converter logic to:
convert the digital signal originating from the network attached storage device from a first signal format to a second signal format, different from the first signal format; and
transmit the digital signal in the second signal format through the at least one data output port.

10. The network attached storage device of claim 9, further comprising:
a remote control; and
logic to:
transmit, to a digital rendering device, a settings menu;
receive, from the remote control, at least one setting selection for input and output data formats.

11. The network attached storage device of claim 9, further comprising:
an input/output interface; and
logic to:
display, on the input/output interface, current data format selections and data format options;
receive, in the digital adapter, data format selections; and
process, in the digital adapter, the selected data format selections.

12. The network attached storage device of claim 9, further comprising logic to:
transmit, to the digital rendering device, current data format selections and data format options;
display, on the digital rendering device, current data format selections and data format options;
receive, in the digital adapter, data format selections; and
process, in the digital adapter, the selected data format selections.

13. The network attached storage device of claim 9, further comprising:
an input/output interface; and
logic to:
detect the digital data format from at least one data input port and at least one data output port;
select a default conversion routine;
present the default conversion routine on the input/output interface;
permit selection of a different conversion routine; and
change conversion routine as per the selection from the input/output interface.

14. The network attached storage device of claim 9, further comprising logic to:
detect the signal format of the digital signal originating from a network attached storage device;
detect the signal format of the connection with a digital rendering device;
select a default conversion routine;
present the default conversion routine on the digital rendering device;
permit selection of a different conversion routine; and
change conversion routine as per the selection from the digital rendering device.

15. The network attached storage device of claim 9, wherein the digital signal received from at least one of the data input ports comprises data received through a serial interface.

16. The network attached storage device of claim 9, wherein the digital signal transmitted from at least one of the data output ports comprises data transmitted through a renderable physical interface.

17. A method, comprising:
receiving, by a digital adapter, digital signals;
converting, by a digital adapter, the digital signals; and
transmitting, by a digital adapter, converted digital signals.

18. The method of claim 17, wherein receiving, by a digital adapter, a digital signal comprises:
detecting the format of data in the digital signal;
selecting a default conversion routine;
presenting the default conversion routine on a input/output interface;
permitting selection of a different conversion routine;
changing conversion routine as per the selection from the input/output interface; and
in response to a determination that the digital adapter supports the detected format, initiating a digital signal data converter.

19. The method of claim 17, wherein the receiving, by a digital adapter, digital signals comprises receiving data through a serial interface.

20. The method of claim 17, wherein transmitting, by a digital adapter, a converted digital signal comprises transmitting data to a renderable physical interface.
